(19) United States
(12) Patent Application Publication
(10) Pub. No.: US 2007/0228666 A1
(43) Pub. Date: Oct. 4, 2007

(54) Cylinder head gasket

(75) Inventors: Thomas Schumacher, Riederich (DE); Klaus Bendl, Oberderdingen (DE); Peter Schweizer, Grafenberg (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: ElringKlinger AG

(21) Appl. No.: 11/723,015

(22) Filed: Mar. 15, 2007

(30) Foreign Application Priority Data
Mar. 29, 2006 (DE) 10 2006 014 384.1

(51) Int. Cl. F02F 11/00

(52) U.S. Cl. 277/592

(57) ABSTRACT

1. Cylinder Head Gasket

2. In a cylinder head gasket (1) for an internal combustion piston engine, having at least one gasket layer (21, 23, 25) of metallic material which defines the main gasket plane and which has at least one combustion chamber through opening (3), on the edge of which there is a circular ring-shaped combustion chamber sealing area (15), the combustion chamber sealing area (15) is vertically profiled such that measured perpendicular to the main gasket plane it has a different thickness in different peripheral areas.

The invention relates to a cylinder head gasket for an internal combustion piston engine, having at least one gasket layer of metallic material which defines the main gasket plane and which has at least one combustion chamber through opening, on the edge of which there is a circular ring-shaped combustion chamber sealing area.

Cylinder head gaskets such as these, which can be clamped by means of cylinder head bolts between the cylinder head and the engine block of an internal combustion engine, are prior art.

In order to reliably seal around the pertinent combustion chamber with the combustion chamber sealing area of the cylinder head gasket by tightening the cylinder head bolts, a relatively great compressive load per unit area must be ensured throughout, i.e., over the entire periphery of the combustion chamber sealing area. As a result of the operating conditions which change over time and which prevail in engine operation, it is technically difficult to meet this requirement. Prevailing high temperatures and dynamic sealing gap movements along the periphery of the combustion chamber sealing area lead to nonuniform compressive loading per unit area and thus to endangering the operating reliability of the cylinder head gasket.

The object of the invention is to devise a cylinder head gasket in which in the installed state and during engine operation a compressive sealing load per unit area which is uniform over the periphery of the combustion chamber sealing area is ensured.

In a cylinder head gasket of the initially mentioned type, this object is achieved as claimed in the invention in that the combustion chamber sealing area is vertically profiled such that measured perpendicular to the main gasket plane, it has a different thickness in different peripheral areas.

In that, as claimed in the invention, the thickness of the sealing area which is active on the sealing gap is different in areas, which leads to a locally different compressive sealing load per unit area in the installation process by tightening the cylinder head bolts, influences can be equalized which arise in engine operation by locally different thermal loads causing dynamic changes on the gasket gap which can be compensated by locally different choice of the initial thickness, such that in engine operation the compressive sealing load per unit area around the periphery of the sealing area becomes uniform in engine operation. These effects have already become known in static changes relative to gasket configurations.

DE 102 21 731 A1 discloses a metallic seal ring which has peripheral vertical profiling. This seal ring however forms a seal between the cylinder liner and a sealing surface located within the engine block. This seal ring is located at a site isolated from the combustion chamber where operating conditions prevail which are completely different than on the combustion chamber sealing area of the cylinder head gasket bordering the combustion chamber. But it was found that the vertical profiling as claimed in the invention especially under the operating conditions prevailing on the combustion chamber sealing area enables the compressive sealing load per unit area be made uniform during engine operation, as desired.

If, as is generally the case in cylinder head gaskets, the respective combustion chamber sealing area is surrounded by bolt passage openings for cylinder head bolts, which are configured at intervals from one another at a radial distance from the combustion chamber sealing area, the combustion chamber sealing area preferably in the peripheral areas located between the bolt passage openings has a greater thickness than in peripheral areas nearer the bolt passage openings. In this connection, the extent of the changes in thickness matched to the material stiffness of the material parts located between the areas of the bolt passage openings where the bolt force is applied is approximately in the micron range, for example in the range from 20 to 60 μm in practical embodiments.

The thicknesses of the combustion chamber sealing area which are different in areas can be produced by plastic deformation, for example by rolling treatment, extrusion or by hot extrusion.

If there is a bead running along the periphery of the combustion chamber sealing area in the gasket layer, it can have a different geometry and/or different material properties as a contribution to formation of the vertical profiling along the periphery caused by the locally different thicknesses of the combustion chamber sealing area. If before installation of the cylinder head gasket, that is to say, to establish the delivery state, plastic deformation in the combustion chamber sealing area is carried out, due to the varied geometry of the bead or locally different material properties such as stiffness, this deformation leads to the correspondingly desirable vertical profiling.

In cylinder head gaskets which are formed by a combination of several gasket layers, on the combustion chamber sealing area a layer containing the bead can be overlapped by a layer which has been folded over the bead and which forms the edge-side enclosure of the combustion chamber sealing area. In this connection, the resulting vertical profiling arises due to the plastic deformation of the gasket layer or layers adjoining the bead and the bead itself, the extent of deformation of the bead being influenced by the optionally different geometries and optionally locally different stiffness of the bead.

The invention will be detailed below using the embodiment shown in the drawings.

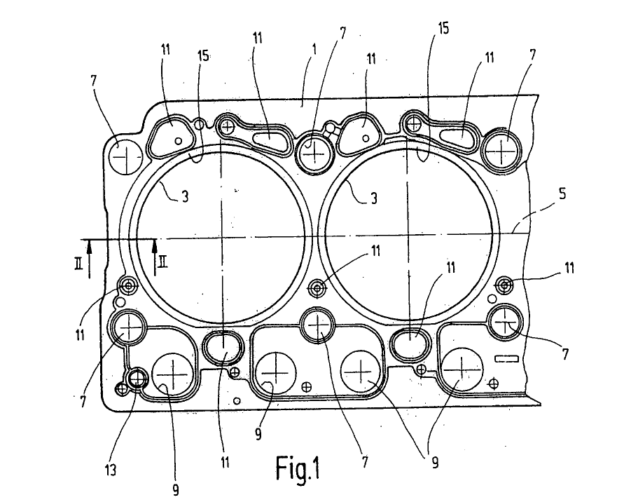

FIG. 1 shows a cutaway elevational view of a cylinder head gasket according to one embodiment of the invention for a multicylinder engine;

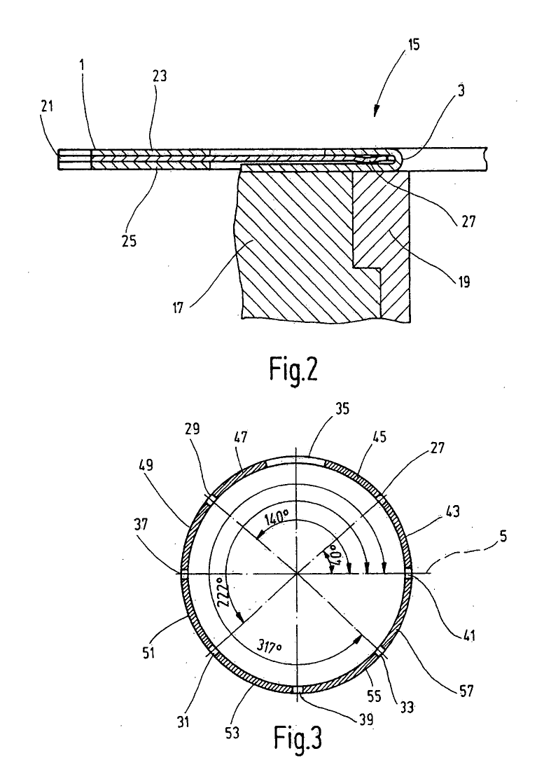

FIG. 2 shows a partial section which has been greatly enlarged compared to FIG. 1 according to line II-II in FIG. 1, and

FIG. 3 shows a diagram illustrating the vertical profiling to be provided in the example of FIGS. 1 and 2.

The cylinder head gasket 1 which is shown in FIG. 1 has several combustion chamber openings 3 for several engine cylinders located in a row along the longitudinal axis 5 of the engine, in the cutaway from FIG. 1 only the combustion chamber openings 3 for the first and the second cylinder being visible. Several openings or passages surrounded by gasket edges are assigned to each combustion chamber opening 3, distributed around its periphery, specifically bolt passage openings 7 which surround the combustion chamber opening in a regularly distributed positional configuration, and passages 9 for valve lifters. Moreover there are passages 11 surrounded by gasket edges as a connection for water channels and an oil channel passage 13 in the manner conventional for these cylinder head gaskets.

On the edge of the combustion chamber openings 3 the cylinder head gasket 1 forms one combustion chamber sealing area 15 at a time, which will be detailed below with reference to FIGS. 2 and 3. As is to be seen from FIG. 2, this embodiment of the cylinder head gasket 1 is a combination of several metallic gasket layers, specifically an inner layer 21 with an outer support 23 and 25. In the mounted state the cylinder head gasket 1 rests on the engine block 17 such that the inner edge of the combustion chamber opening 3 which forms the combustion chamber sealing area 15 is located above the top edge of the cylinder lining 19 of the pertinent cylinder, the top of the cylinder lining 19 being flush with the top of the cylinder block 17.

In the combustion chamber sealing area 15, in the middle layer 21 there is a bead 27 which is arched outwardly against the engine block 17 and which extends peripherally along the entire edge of the combustion chamber opening 3. In the production of the cylinder head gasket 1 as claimed in the invention, in order to bring it into the delivery state before actual installation, plastic deformation takes place in the combustion chamber sealing area 15. This is configured such that along the periphery of the combustion chamber opening 3 there is vertical profiling, i.e., a locally different thickness, before the cylinder head gasket I is installed, i.e., is clamped between the cylinder head and the engine block 17. As already mentioned, this deformation can take place by rolling treatment or extrusion (cold or hot) in selected peripheral sections. In this connection, in addition to the plastic deformation of the gasket layers 23, 25 adjoining the bead 27, there is corresponding locally varied flat compression of the bead 27, so that overall a combustion chamber sealing area 15 with locally different thicknesses is obtained. As a contribution to the desired vertical profiling, the bead 27 in addition can be shaped or arched differently in different sections or can be provided with different material properties (stiffness). In each instance, the locally different thicknesses of the combustion chamber sealing area 15 are selected before the cylinder head gasket 1 is mounted, such that after tightening the cylinder head bolts (not shown) which clamp the cylinder head gasket 1 and under the operating conditions prevailing in engine operation, a uniform compressive sealing load per unit area on the combustion chamber sealing area 15 around the combustion chamber opening 3 results.

The bead 27, which is arched out like a circular arc in the direction to the engine block, is located with its apex line above the top of the cylinder lining 19 which sits in the engine block 17, as is shown in FIG. 2. As is likewise apparent therefrom, between the end edge of the layer 21 which borders the bead 27 and the enclosure of the layer 21 formed by the layers 23, 25, there is a small intermediate space which enables narrowly limited relative motion of the layers 21, 23, and 25 especially for compensation of thermal expansion.

FIG. 3 shows a diagram in illustration of the local thickness changes of the combustion chamber sealing area 15 yielding the desired vertical profiling, the angular positions of corresponding areas relative to the longitudinal axis 5 of the engine being given in angular degrees. The areas aligned to the through bolt openings 7 are identified as 27, 29, 31 and 33. The areas located between them are in turn identified as 43, 45, 47, 49, 51, 53, 55, and 57. In this example the operating conditions in engine operation are such that the thickness is least in the areas 27, 29, 31 and 33 which are aligned to the bolt passage openings 7, while the thickness in the intermediate areas 35, 37, 39 and 41 is conversely elevated, in FIG. 3 the transition areas 43, 45, 47, 49, 51, 53, 55, and 57 which lie in between being shown crosshatched. Compared to the areas 29, 31, 33 and 41 which are aligned to the cylinder head bolts and which have the smallest thickness, the areas 35, 37, 39, and 41 lying in between in one practical embodiment are each reduced in their thickness by approximately 40 to 60 μm.

The crosshatched areas which identify the increase and decrease of the thickness each form a slight rise or drop so that the change in thickness between the areas takes place more or less continuously.

It goes without saying that the invention, although it has been explained using the example of a cylinder head gasket 1 for a multicylinder engine, can be equally well used for a cylinder head gasket for only a single engine cylinder or for an embodiment which calls for its own gasket configured next to one another for several engine cylinders.

1. Cylinder head gasket (1) for an internal combustion piston engine, having at least one gasket layer (21, 23, 25) of metallic material which defines the main gasket plane and which has at least one combustion chamber through opening (3), on the edge of which there is a circular ring-shaped combustion chamber sealing area (15), characterized in that the combustion chamber sealing area (15) is vertically profiled such that measured perpendicular to the main gasket plane it has a different thickness in different peripheral areas.

2. The cylinder head gasket as claimed in claim 1, wherein the respective combustion chamber sealing area (15) is surrounded by bolt passage openings (7) for cylinder head bolts, which are configured at intervals from one another at a radial distance from the combustion chamber sealing area (15), and wherein the combustion chamber sealing area preferably in the peripheral areas (35, 37, 39, 41) located between the bolt passage holes (7) has a greater thickness than in peripheral areas (27, 29, 31, 33) nearer the bolt passage holes (7).

3. The cylinder head gasket as claimed in claim 2, wherein the course of the vertical profiling caused by different thicknesses of the peripheral areas of the combustion chamber sealing area (15) along the periphery is selected such that in the installed state along the periphery the desired compressive sealing load per unit area is continuously formed.

4. The cylinder head gasket as claimed in claim 2, wherein the thicknesses of the combustion chamber sealing area (15) which are different in areas are produced by plastic deformation.

5. The cylinder head gasket as claimed in claim 4, wherein the deformation is produced by rolling treatment.

6. The cylinder head gasket as claimed in claim 4, wherein the deformation is produced by extrusion.

7. The cylinder head gasket as claimed in claim 4, wherein there is a bead (27) which runs along the periphery of the combustion chamber sealing area (15) in the gasket layer (21).

8. The cylinder head gasket as claimed in claim 7, wherein the bead (27) has a different geometry and/or different material properties as a contribution to formation of the vertical profiling along the periphery caused by the locally different thicknesses of the combustion chamber sealing area (15).

9. The cylinder head gasket as claimed in claim 8, wherein it is a combination of several gasket layers (21, 23, 25), on the combustion chamber sealing area (15) the layer (21) which contains the bead (27) being overlapped by at least one layer (23, 25) which has been folded over the bead (27) and which forms the edge-side enclosure of the combustion chamber sealing element (15).

10. The cylinder head gasket as claimed in claim 9, wherein the gasket layer (23, 25) folded over the bead (27) extends essentially over the entire surface of the cylinder head gasket (1).

11. The cylinder head gasket as claimed in claim 2, wherein in the intermediate areas (35, 37, 39, 41) located between the bolt passage openings (7) the increase of the thickness matched to the different operating conditions prevailing in these areas is chosen to be different.

12. The cylinder head gasket as claimed in claim 1, wherein the thickness changes between the peripheral areas (29, 31, 33, 35, 37, 39, 41) take place in a continuous, gentle transition.

13. Process for producing a cylinder head gasket as claimed in claim 9, wherein the vertical profiling is effected on the combination of several gasket layers (21, 23, 25) by means of a forming tool which acts from the outside on the combination, on the combustion chamber sealing area (15) the layer (21) containing the bead (27) being overlapped by at least one layer (23, 25) which has been folded over the bead (27) and which forms the edge-side enclosure of the combustion chamber sealing area (15).
